(19) United States
(12) Patent Application Publication
(10) Pub. No.: US 2025/0053960 A1
(43) Pub. Date: Feb. 13, 2025

(54) A TIP SYSTEM AND METHOD

(71) Applicants: Ibrahim MERCAN, Mugla (TR); Necdet Türker ERGÜN, Küçükyali, Izmir (TR)

(72) Inventor: Ibrahim MERCAN, Mugla (TR)

(21) Appl. No.: 18/688,991

(22) PCT Filed: Nov. 29, 2022
(86) PCT No.: PCT/TR2022/051379

§ 371 Date: Mar. 4, 2024

(51) Int. Cl. G06Q 20/36; G06Q 20/32; G06Q 40/04

(52) U.S. Cl. CPC G06Q 20/36; G06Q 20/326; G06Q 40/04

(57) ABSTRACT

Disclosed are a system and method providing online payment of tip to service sector employees by a virtual wallet created through a mobile application.

### THE RELATED ART

The Invention relates to a system and method making tip giving procedures easy in service sector in fields of hotel, restaurant, package service, cargo delivery services etc.

The Invention particularly relates to a system and method providing online payment of tip to service sector employees by means of a virtual wallet created through a mobile application.

### BACKGROUND OF THE INVENTION

Today there are many personnel working in service sector fields of hotel, restaurant, package service, cargo delivery etc. A customer receiving service may give a tip in addition to service fee and award the personnel rendering service.

In current application tip systems are realized under management of a single person. For instance, when a customer paying his/her bill at a restaurant wishes to give a tip to the employee with whose service the customer is pleased, tip amount is distributed with discretion of manager/supervisor etc. at the said enterprise. In addition, the received amount is not under control of the enterprise and so there is no income declaration either. It remains as an earning without taxation.

When the literature is searched, an application numbered 2013/05949 and entitled “Tip or tip payment system” is seen. The said application discloses a system about payment of an amount as tip in consideration of all employees' services received from waiters at restaurants, bellboys, musicians, valets at hotels, package delivery staff, hairdresser or similar places. The system does not disclose an embodiment enabling payment via virtual wallets and crypto assets.

As a result, due to above described disadvantages and inadequacy of existing solutions, it has been necessary to make development in the related art.

### AIM OF THE INVENTION

The invention inspired from existing situations aims to solve the disadvantages described above.

Primary aim of the invention is to disclose a system and method providing online payment of tip to service sector employees by means of a virtual wallet created through a mobile application.

Another aim of the invention is to disclose a system and method providing fair distribution of tips among employees.

A further aim of the invention is to disclose a system and method making tip payment and receipt easy.

In order to achieve above mentioned aims, the invention is a system providing tip giving and receiving among customer and service personnel. According to it the system comprises a mobile application providing
Establishment of a virtual wallet by user,
Depositing money into the created virtual wallet,
transferring money between created virtual wallets,
purchasing crypto assets from desired stock exchange,
transferring purchased crypto asset to virtual wallet and
enabling transfer of crypto assets among users by means of a connection unit and/or virtual wallet address
a customer device running said mobile application thereon and having square code reading capability,
a personnel device running said mobile application thereon and enabling service personnel to receive tip via a virtual wallet created in said mobile application.

The invention also discloses a method providing tip giving and receiving between customer and service personnel. According to it, the method comprises process steps of
Installation of a mobile application enabling customer wishing to give tip and/or service sector employee to receive tip to create virtual wallet on customer device and/or personnel device-, and creation of virtual wallet,
Depositing money and/or crypto asset into virtual wallet by customer wishing to give tip by means of his/her mobile application installed on customer device,
realization of tip transfer by customer wishing to give tip by reading connection unit by mobile application running on personnel device or entering virtual wallet address of the personnel into mobile application by mobile device providing transfer of money to virtual wallet created by mobile application on personnel device and owned by personnel.

The structural and characteristics features of the invention and all advantages will be understood better in detailed descriptions with the FIGURES given below and with reference to the FIGURES, and therefore, the assessment should be made taking into account the said FIGURES and detailed explanations.

### BRIEF DESCRIPTION OF THE DRAWINGS

FIG. 1 is a schematic view of system of the invention.

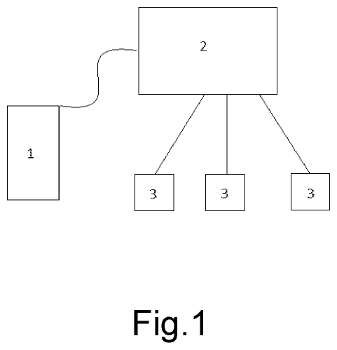

### DESCRIPTION OF PART REFERENCES

1. Customer device
2. Mobile application
3. Personnel device

### DETAILED DESCRIPTION OF THE INVENTION

In this detailed description, the preferred embodiments of the system and method being subject of the invention have been described only for purpose of better understanding of the matter.

The invention is a system providing tip payment and receipt by and between customer and service personnel. Accordingly, it comprises mobile application (2) providing creation virtual wallet by user, depositing money into created virtual wallet, conduct of transfers between created virtual wallets, purchase of crypto assets from any stock exchanges, transfer of purchased crypto asset to virtual wallet and transfer of crypto assets between users by means of a connection unit and/or virtual wallet address, a customer device (1) whereon said mobile application (2) run and capable to read square code, a personnel device (3) whereon said mobile application (2) runs and allowing service personnel to receive tip via a virtual wallet created at said mobile application (2).

A preferred application of the system is characterized by a connection unit QR code providing transfer of money between users via said mobile application (2).

### Operating Principle of the System is as Follows:

In the system user is defined as customer wishing to give tip and personnel to receive tip or corporate user.

The customer wishing to give tip or personnel to receive tip creates a virtual wallet on a mobile application (2) running on a customer device (1) and/or personnel device (3). In a preferred application of the system said virtual wallet is created with a 24-word security code.

User signs up by entering his/her personal details (password-rescue password-mail address etc. to verify the wallet owner) (2).

Mobile application (2) allows user to buy crypto asset/fund from any stock exchanges. Crypto assets from various stock exchanges or banks are transferred to virtual wallet created in mobile application (2) by entering virtual wallet address or wallet square code. When relater stock exchange (Fir instance, Binance, Rain etc.) is entered, When clicking onto transfer button, entering virtual wallet address in mobile application (2) or reading square code by customer device (1) camera, crypto asset is transferred to desired wallet.

Similarly, in the tip process customer provides reading of square code containing virtual wallet address created on the mobile application (2) running on corporate user or personnel's personnel device (3) to whom tip will be given by means of customer device (1) or enters wallet address of received into mobile application (2) and makes transfer between virtual wallets.

In a preferred application of the system, payment is made to said virtual wallet by credit card and crypto asset or fund can be purchased by credit card.

1. A system providing tip giving by a customer and receiving by service personnel, the system comprising:
a mobile application providing performance of
creation of a virtual wallet by a user,
depositing money into the created virtual wallet,
transferring money between created virtual wallets,
purchasing crypto assets from a desired stock exchange,
transferring purchased crypto assets to the virtual wallet, and
enabling transfer of the crypto assets among users by means of a connection unit and/or a virtual wallet address,
a customer device running said mobile application thereon and having square code reading capability, and
a personnel device running said mobile application thereon and enabling service personnel to receive a tip via a virtual wallet created in said mobile application.

2. The system according to claim 1, comprising reading of a square code by a connection unit providing crypto asset/fund transfer between users.

3. A method providing tip giving by a customer and receiving by service personnel comprising the following process steps:
installation of a mobile application enabling a customer wishing to give tip and/or service sector employee to receive tip to create a virtual wallet on a customer device and/or personnel device, and creation of a virtual wallet,
depositing money and/or crypto asset into the virtual wallet by the customer wishing to give tip by means of his/her mobile application installed on the customer device,
realization of tip transfer by the customer wishing to give tip by reading a connection unit by the mobile application running on the personnel device or entering a virtual wallet address of the personnel into the mobile application by mobile device providing transfer of money to virtual wallet created by mobile application on the customer device.

4. The method according to claim 3, comprising the process steps of depositing funds and/or crypto asset into the virtual wallet by the customer wishing to give tip from his/her customer device by reading a square code by mobile application on the customer device.

5. The method according to claim 3, comprising the process steps of depositing funds and/or crypto asset into the virtual wallet by the customer wishing to give tip from his/her virtual wallet address via the mobile application running on the customer device.

6. The method according to claim 3, comprising the process step of creation of the virtual wallet by preferably a 24-word security code on the mobile application running on the customer device and/or personnel device.

7. The method according to claim 3, comprising the process step of signing into the mobile application by the user upon entering his/her personal details.

8. The method according to claim 3, comprising the process step of depositing funds from a credit card into the virtual wallet created on said mobile application.
